(19) United States
(12) Patent Application Publication
(10) Pub. No.: US 2006/0242112 A1
(43) Pub. Date: Oct. 26, 2006

(54) Hierarchical storage management apparatus, method, and program

(75) Inventor: Jun Hikita, Kanagawa (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Sony Corporation, Shinagawa-Ku (JP)

(21) Appl. No.: 11/393,922

(22) Filed: Mar. 31, 2006

(30) Foreign Application Priority Data
Apr. 20, 2005 (JP) 2005-121832

(51) Int. Cl. G06F 17/30

(52) U.S. Cl. 707/1

(57) ABSTRACT

A hierarchical storage management apparatus manages data access to a plurality of hierarchical storage devices that have different performances. The hierarchical storage management apparatus includes the following elements: an access history recorder that records an access history of a data file stored in one of the plurality of hierarchical storage devices, the access history being recorded when the data file is accessed and including information about a hierarchical level in which the accessed data file is stored; and an image data generator that generates image data that shows an access status using information about one or more specified arbitrary hierarchical levels, each piece of the information being extracted from the access history.

### CROSS REFERENCES TO RELATED APPLICATIONS

The present invention contains subject matter related to Japanese Patent Application JP 2005-121832 filed in the Japanese Patent Office on Apr. 20, 2005, the entire contents of which are incorporated herein by reference.

### BACKGROUND OF THE INVENTION

1. Field of the Invention

The present invention relates to hierarchical storage management apparatuses, methods, and programs. More particularly, the present invention relates to a hierarchical storage management apparatus, method, and program for managing data access to a plurality of hierarchical storage devices having a plurality of different performances.

2. Description of the Related Art

Computer storage devices used for storing program data files and data files to be processed have been required to have larger capacities as file sizes increase, as well as higher speeds (shortening time of access thereto) so as to shorten processing time of computers. In order to meet the requirements, a method of managing storage media for storing program data files, etc. using HSM (Hierarchical Storage Management) software exists.

In a hierarchical storage management apparatus using the HSM software, for example, some different kinds of storage devices with differing performances such as, in order of decreasing processing speed and performance, a non-high-processing-speed hard disk, a removable medium included in an automated library device, and an off-line removable medium extracted from the automated library device are hierarchically formed. The removable medium may be an MO (Magneto Optical) disk, a DVD (Digital Versatile Disc), or a magnetic tape.

These storage devices differ from each other in terms of processing speed and cost per unit storage capacity. The highest performance hard disk in hierarchical levels of the storage devices has a high cost per unit storage capacity. Moving down through the hierarchical levels, the processing speed is reduced, but the cost per unit storage capacity becomes lower.

The recording and management of files in each hierarchical level are performed using the HSM software. The storage destination of a data file is moved using the HSM software on the basis of a policy defined as “storing a more frequently accessed file in a more expensive and higher-speed medium” (see, for example, Japanese Unexamined Patent Application Publication No. 2000-200205, paragraphs [002] to [0005] and FIG. 1). This system implementation allows a large amount of data to be wrote and read effectively.

### SUMMARY OF THE INVENTION

In order to evaluate whether a hierarchical storage management apparatus using HSM software is being appropriately operated, operators have to acquire necessary information from file attribute information, used storage space and the number of accesses of/to all of storage devices and each hierarchical level, etc. and have to create a graph or the like using the acquired information.

It is desirable to provide a hierarchical storage management apparatus, method, and program capable of easily providing information for evaluating operational efficiency of file management to operators.

According to an embodiment of the present invention, there is provided a hierarchical storage management apparatus for managing data access to a plurality of hierarchical storage devices that have different performances. The hierarchical storage management apparatus includes the following elements: an access history recorder that records an access history of a data file stored in one of the plurality of hierarchical storage devices; and an image generator that generates image data that shows an access status using information about one or more specified arbitrary hierarchical levels, each piece of the information being extracted from the access history.

According to the hierarchical storage management apparatus, when a data file stored in one of the plurality of hierarchical storage devices is accessed, an access history including information about a hierarchical level in which the accessed data file is stored is recorded by the access history recorder. In addition, image data showing an access status is generated by the image data generator using information about one or more specified arbitrary hierarchical levels, each piece of the information being extracted from the access history.

According to an embodiment of the present invention, there is provided a hierarchical storage management method of managing data access to a plurality of hierarchical storage devices that have different performances. The hierarchical storage management method includes the steps of: causing an access history recorder to record an access history of a data file stored in one of the plurality of hierarchical storage devices, the access history being recorded when the data file is accessed and including information about a hierarchical level in which the accessed data file is stored; and causing an image data generator to generate image data that shows an access status using information about one or more specified arbitrary hierarchical levels, each piece of the information being extracted from the access history.

According to the hierarchical storage management method, when a data file stored in one of the plurality of hierarchical storage devices is accessed, an access history including information about a hierarchical level in which the accessed data file is stored is recorded by the access history recorder. In addition, image data showing an access status is generated by the image data generator using information about one or more specified arbitrary hierarchical levels, each piece of the information being extracted from the access history.

According to the hierarchical storage management apparatus according to an embodiment of the present invention, operators can easily receive useful information for evaluating operational efficiency of file management of the hierarchical storage management apparatus in the form of image data without having to perform complicated operations, since when a data file is accessed, an access history including information about a hierarchical level in which the accessed data file is stored is recorded in advance, whereby image data showing an access status of an arbitrary hierarchical level can be generated with simple processes.

### BRIEF DESCRIPTION OF THE DRAWINGS

FIG. 1 is a diagram showing processing functions of a hierarchical storage management apparatus according to an embodiment of the present invention;

FIG. 2 is a diagram showing an exemplary hardware configuration according to an embodiment of the present invention;

FIG. 3 is a flowchart showing a procedure of a file access information recording process that is executed by a hierarchical storage management apparatus according to an embodiment of the present invention;

FIG. 4 is a flowchart showing a procedure of a storage usage information displaying process that is executed by a hierarchical storage management apparatus according to an embodiment of the present invention;

FIG. 5 is a diagram showing an exemplary display of a user interface according to an embodiment of the present invention;

FIG. 6 is a diagram showing an exemplary display of a number of accesses graph;

FIG. 7 is a diagram showing an exemplary display of an annual number of accesses table created when a research item (5) is selected;

FIG. 8 is a diagram showing an exemplary display of a monthly number of accesses table created when a research item (5) is selected; and

FIG. 9 is a diagram showing an exemplary display of a daily number of accesses graph created when a research item (5) is selected.

### DESCRIPTION OF THE PREFERRED EMBODIMENT

An embodiment of the present invention will now be described in detail with reference to the accompanying drawings.

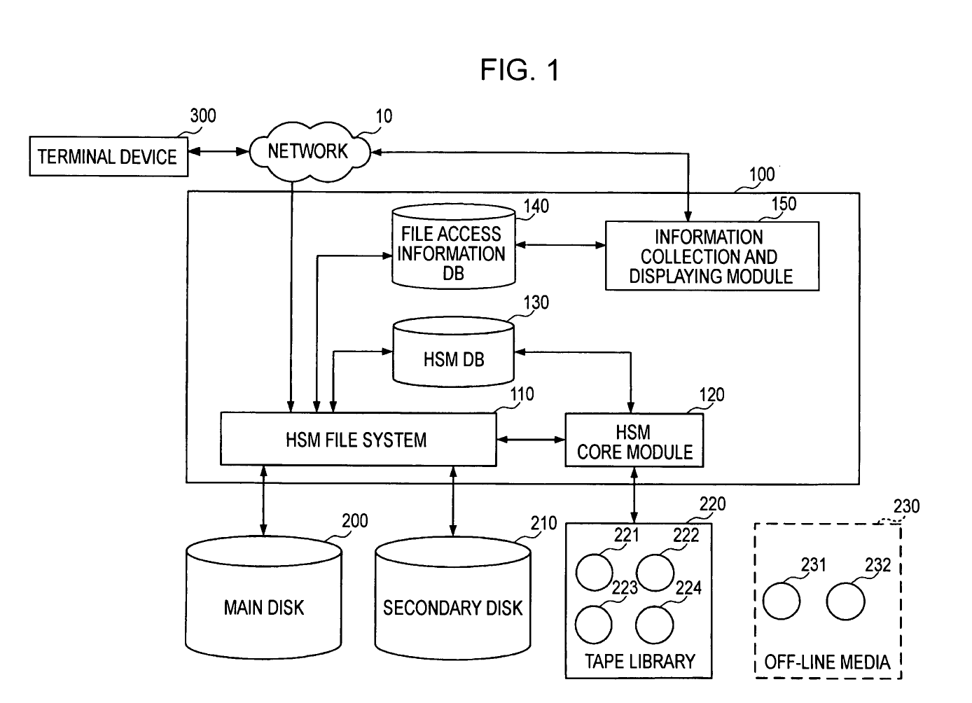

FIG. 1 is a diagram showing processing functions of a hierarchical storage management apparatus according to an embodiment of the present invention. As shown in FIG. 1, a hierarchical storage management apparatus 100 is provided with an HSM file system 110, an HSM core module 120, an HSM database (DB) 130, a file access information database (DB) 140, and an information collection and displaying module 150. The hierarchical storage management apparatus 100 is connected to a main disk 200, a secondary disk 210, and a tape library 220, all of which are used as hierarchical storage devices by the hierarchical storage management apparatus 100. A terminal device 300 is connected to the hierarchical storage management apparatus 100 via a network 10.

The HSM file system 110 is connected to the HSM core module 120, the HSM database 130, the file access information database 140, the main disk 200, and the secondary disk 210. The HSM file system 110 records or reads a data file onto or from the main disk 200 or the secondary disk 210 in response to a request from the terminal device 300. In addition, the HSM file system 110 records or reads a data file via the HSM core module 120 onto or from one of magnetic tapes 221, 222, 223 and 224, which are stored in the tape library 220.

This HSM file system 110 accesses a data file stored in one of these recording media on the basis of location information stored in the HSM database 130, and then updates the HSM database 130. The HSM file system 110 manages the HSM database 130 so as to efficiently access the data file stored in one of these recording media, by moving the storage destination of the data file in accordance with a policy set in advance, and then updating the HSM database 130.

Furthermore, as will be described in detail hereinafter, the HSM file system 110 records file access information on the file access information database 140, when recording or reading the data file onto or from the recording medium.

The HSM core module 120 records and reads a data file onto or from one of the magnetic tapes 221, 222, 223 and 224, which are stored in the tape library 220, on the basis of location information stored in the HSM database 130 in response to a request from the HSM file system 110. After the recording and reading operation, the HSM core module 120 updates the HSM database 130.

The HSM database 130 is connected to the HSM file system 110 and the HSM core module 120. The HSM database 130 has location information about data files, each of which is stored in the main disk 200, the secondary disk 210, or one of the magnetic tapes 221, 222, 223, and 224 included in the tape library 220.

The file access information database 140 is connected to the HSM file system 110 and the information collection and displaying module 150. The file access information database 140 receives file access information from the HSM file system 110 or the HSM core module 120 when a data file stored in the main disk 200, the secondary disk 210, or the tape library 220 is accessed, and then stores the received access information.

The information collection and displaying module 150 searches the file access information stored in the file access information database 140 for information that meets a display requirement upon receiving an information collection and displaying instruction from the terminal device 300, and then generates data for creating a graph or a table using the file access information acquired by the search. After that, the information collection and displaying module 150 transmits the data to the terminal device 300 via the network 10. Consequently, a graph or a table can be reproduced and displayed on the terminal device 300.

The main disk 200 functions as a high-speed accessible magnetic disk device. The cost per unit storage capacity of the main disc 200 is higher than that of the other storage devices. The cost per unit storage capacity of the secondary disk 210 is lower than that of the magnetic disk device configuring the main disk 200, but the access speed thereto is lower.

The tape library 220 stores the magnetic tapes 221, 222, 223, and 224, and has a changer function for automatically attaching or removing these magnetic tapes to or from its drives. The speed of access to the tape library 220 is lower than that of the magnetic disk devices, because the magnetic tapes 221, 222, 223 and 224 are used as recording media. However, the cost per unit storage capacity of the tape library 220 is lower than that of the magnetic disk devices. The off-line media 230 are configured by magnetic tapes 231 and 232 removed from the tape library 220, and store and archive extremely infrequently accessed data files.

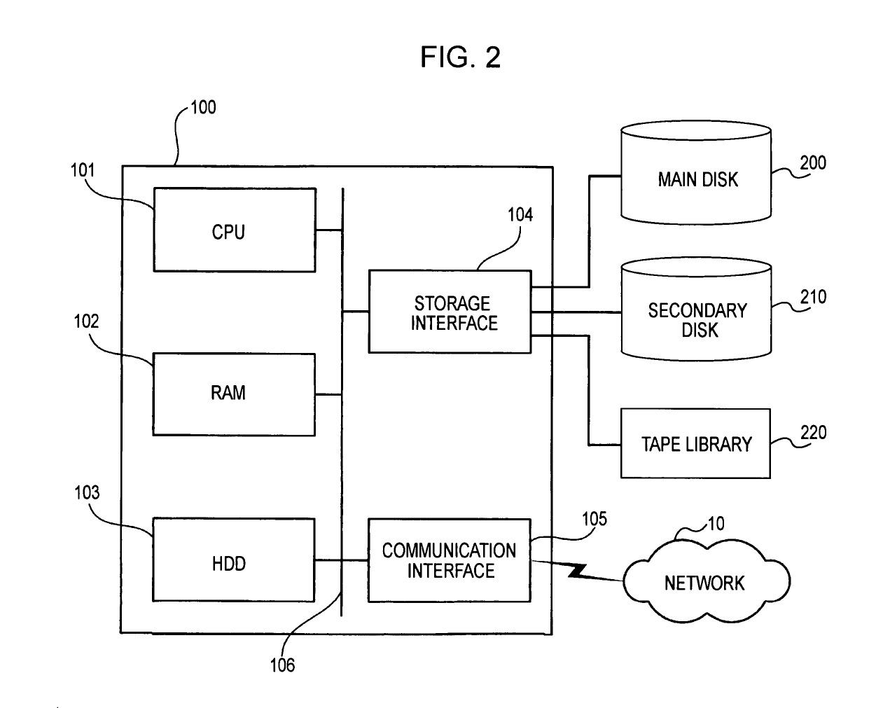

FIG. 2 is a diagram showing an exemplary hardware configuration according to an embodiment of the present invention. The entire hierarchical storage management apparatus 100 is controlled by a CPU (Central Processing Unit) 101. The CPU 101 is connected via a bus 106 to a RAM (Random Access Memory) 102, a hard disk drive (HDD) 103, a storage interface 104, and a communication interface 105.

The RAM 102 temporarily stores at least part of the HSM software or the like executed by the CPU 101. In addition, the RAM 102 stores various data files necessary for processing performed by the CPU 101. The HDD 103 stores the HSM software, file access information, etc.

The storage interface 104 is connected to the main disk 200, the secondary disk 210, and the tape library 220, and writes and reads data onto and from these components. The communication interface 105 is connected to the network 10, and receives and transmits data from and to other computers via the network 10. According to the hardware configuration described above, the processing functions according to this embodiment can be implemented.

Next, processing performed by the hierarchical storage management apparatus 100 will be described using flowcharts.

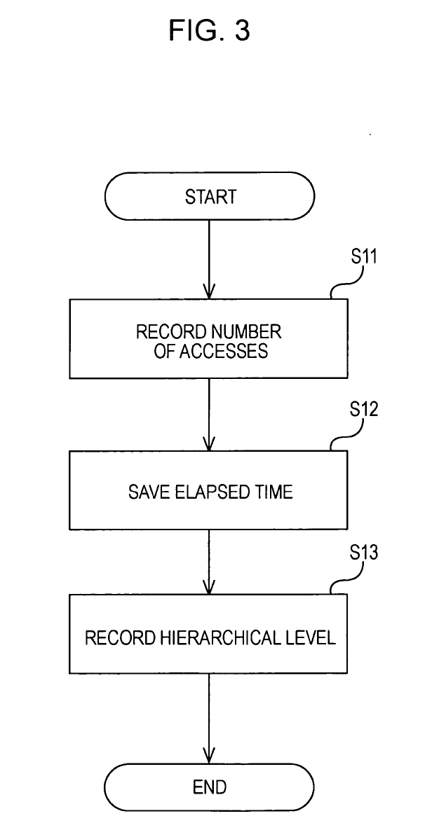

FIG. 3 is a flowchart showing a procedure of a file access information recording process that is executed by the hierarchical storage management apparatus. The recording process shown in FIG. 3 will be described in the order constituent steps are executed.

(Step S11) When a data file stored in one of the storage devices connected to the hierarchical storage management apparatus 100 is accessed (wrote, overwrote, or read), the HSM file system 110 records the number of accesses to the file as well as the date and time of the access on the file access information database 140.

(Step S12) The HSM file system 110 or the HSM core module 120 calculates the elapsed time since each of the file created, last updated, and last accessed times and dates to the file most recently accessed time and date. The file created, last updated, and last accessed times and dates are stored in the accessed file. The calculated elapsed times are stored in the file access information database 140.

(Step S13) The HSM file system 110 or the HSM core module 120 specifies a storage device in which the data file requested via the network 10 from the terminal device 300 is stored, and then stores the information about the specified storage device in the file access information database 140.

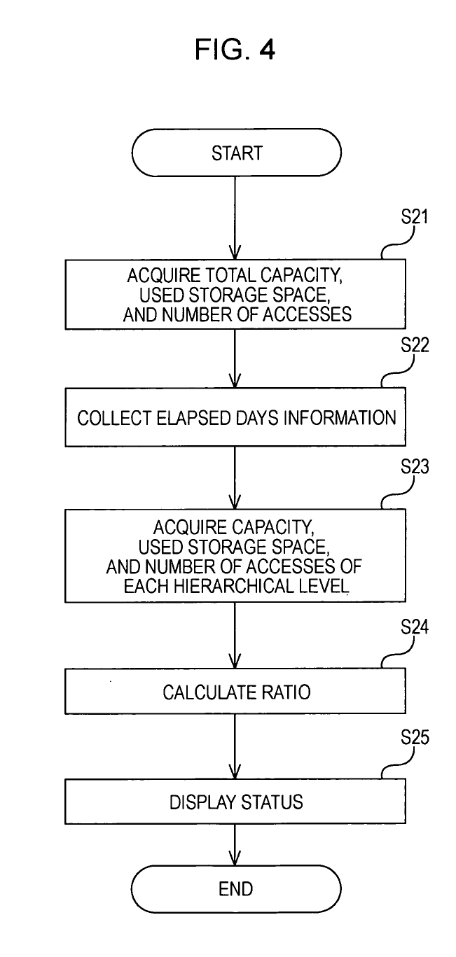

FIG. 4 is a flowchart showing a procedure of a storage usage information displaying process executed by the hierarchical storage management apparatus. The storage usage information displaying process shown in FIG. 4 will be described in the order the constituent steps are executed. The process to be hereinafter described is performed when the hierarchical storage management apparatus 100 receives an information collection and displaying request from the terminal device 300 via the network 10. Each of the steps S21 to S24 is performed in accordance with the request if necessary.

(Step S21) The information collection and displaying module 150 acquires the total capacity, used storage space, and number of accesses of all of the storage devices from the file access information database 140.

(Step S22) The information collection and displaying module 150 acquires and collects information about the elapsed days of the accessed file from the file access information database 140.

(Step S23) The information collection and displaying module 150 acquires the capacity, used storage space, and number of accesses of each of the storage hierarchical levels from the file access information database 140.

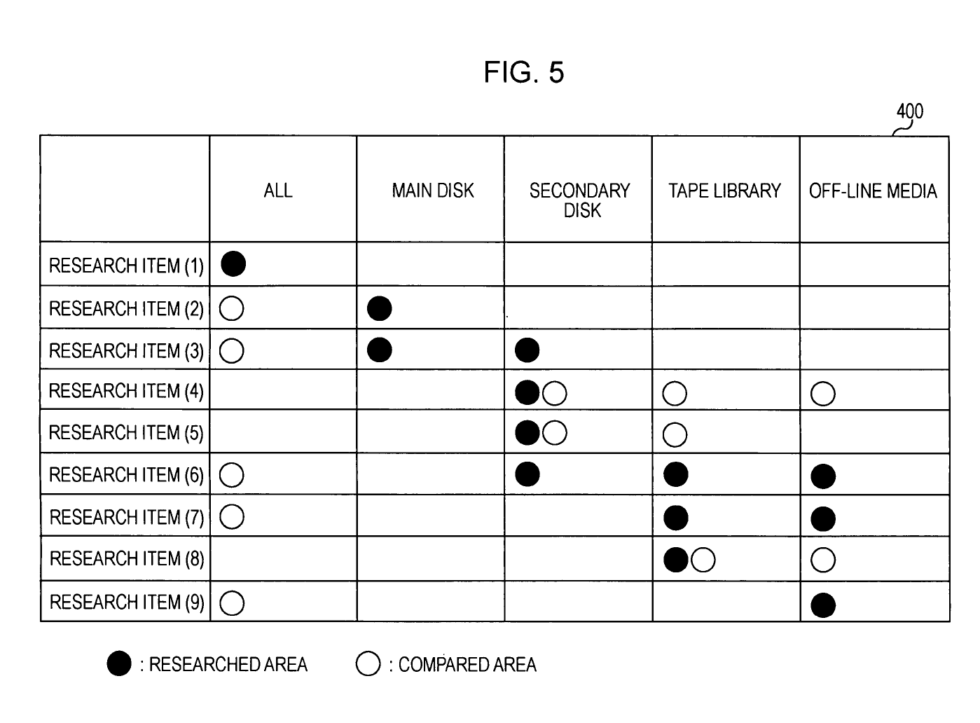

(Step S24) For example, as shown in FIG. 5, the information collection and displaying module 150 acquires necessary information about the capacity, used storage space, or number of accesses of each of one or more storage hierarchical levels, the one or more storage hierarchical levels being specified via a user interface, from the file access information database 140. After that, when a plurality of pieces of information have been acquired, the information collection and displaying module 150 calculates certain kinds of ratio between a plurality of pieces of information having been acquired.

(Step S25) The information collection and displaying module 150 generates data for creating a table or a graph that shows a status of the entirety of the storage hierarchical levels and a status of each of the storage hierarchical levels. In other words, the information collection and displaying module 150 generates data capable of being presented as a table or a graph, using the data calculated in accordance with the performed processing of steps S21 to S24, and then transmits the generated data to the terminal device 300 via the network 10.

When the hierarchical storage management apparatus 100 performs the above-described processing, various graphs or tables can be created using various combinations of the generated data. This will be more specifically described using exemplary displays.

FIG. 5 is an exemplary display of a user interface according to an embodiment of the present invention. For example, operators see a user interface 400, which is provided by the hierarchical storage management apparatus 100 via the network 10, on the terminal device 300. Consequently, the operators can select necessary information for evaluation on the terminal device 300, thereby instructing the hierarchical storage management apparatus 100. As shown in FIG. 5, in the user interface 400, the storage devices provided to the hierarchical storage management apparatus 100 are itemized in terms of the hierarchical levels. Research item numbers (1) to (9) are shown in a first column. In each row corresponding to one of the item numbers, one or more storage devices to be researched and one or more storage devices to be compared with the one or more storage devices to be researched are shown.

The research items (1) to (9) will be described in numerical order. Here, the subject of research is the number of accesses.

(Research item (1)) The number of accesses of all of the storage devices managed by the hierarchical storage management apparatus 100 is researched. (Research item (2)) The number of accesses of all of the storage devices and the number of accesses of the main disk 200 are researched and compared with each other. By researching this item, the ratio of the number of accesses of the main disk 200 to that of all of the storage devices can be researched.

(Research item (3)) The number of accesses of all of the storage devices and the sum of the number of accesses of the main disk 200 and that of the secondary disk 210 are researched and compared with each other. By researching this item, the ratio of the overall number of accesses of the data files stored in the magnetic disks (200 and 210) to the number of accesses of all of the storage devices can be researched.

(Research item (4)) The sum of the numbers of accesses of the secondary disk 210, the tape library 220, and the off-line media 230 and the number of accesses of the secondary disk 210 are researched and compared with each other. By researching this item, the ratio of the number of accesses of the secondary disk 210 to that of the data files that have been moved down to hierarchical levels lower than the hierarchical level of the main disk 200 can be researched.

(Research item (5)) The sum of the numbers of accesses of the secondary disk 210 and the tape library 220 and the number of accesses of the secondary disk 210 are researched and compared with each other. By researching this item, the ratio of the number of accesses of the secondary disk 210 to that of the data files that are available online and have been moved down to hierarchical levels lower than the hierarchical level of the main disk 200 can be researched.

(Research item (6)) The number of accesses of all of the storage devices and the sum of the numbers of accesses of the secondary disk 210, the tape library 220, and the off-line media 230 are researched and compared with each other. In other words, the number of accesses of all of the storage devices and that of the data files that have been moved down to hierarchical levels lower than the hierarchical level of the main disk 200 are researched and compared with each other. The result of this research item is complements that of the research item (2).

(Research item (7)) The number of accesses of all of the storage devices and the sum of the numbers of accesses of the tape library 220 and the off-line media 230 are researched and compared with each other. By researching this item, the ratio of the number of accesses of the data files that are stored in hierarchical levels other than the hierarchical levels of the magnetic disk devices to that of all of the storage devices can be researched. The result of this research item is complements that of the research item (3).

(Research item (8)) The sum of the numbers of accesses of the tape library 220 and the off-line media 230 and the number of accesses of the tape library 220 are researched and compared with each other. By researching this item, the ratio of the number of accesses of the data files that are available online to that of the data files that have been moved down to hierarchical levels lower than the hierarchical levels of the magnetic disk devices can be researched.

(Research item (9)) The number of accesses of all of the storage devices and that of the off-line media 230 are researched and compared with each other.

Operators can evaluate whether the operation of the hierarchical storage management apparatus 100 is being effectively performed by researching the storage devices selected in accordance with the above-described various research items. In addition, operators can easily determine whether the number of the storage devices provided to the hierarchical storage management apparatus 100 is sufficient or insufficient.

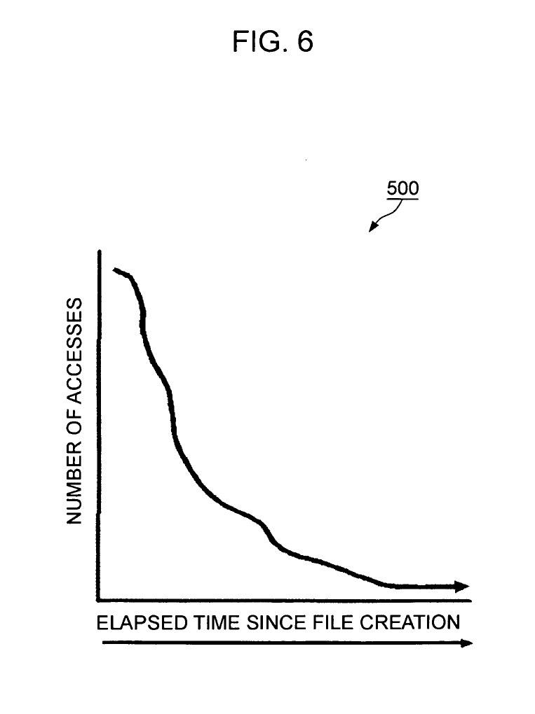

FIG. 6 is an exemplary display of a number of accesses graph. As shown in FIG. 6, a number of accesses graph 500 shows the relationship between an elapsed time since a file was created and the number of accesses to the file.

In the case of the file shown in the number of accesses graph 500, it can be seen that the number of accesses starts to rapidly decrease immediately after the file was created. The file corresponding to access information represented by such a graph may be moved to a low-processing-speed storage device early such as the secondary disk 210 or the tape library 220, namely, to the lower-level hierarchical storage device. Even so, users do not feel inconvenienced.

As described above, the creation of the number of accesses graph 500 allows operators to easily understand how the number of accesses to the file changes with the elapsed time since the file was created. In a case where a certain trend can be seen in the easily understood changes in the number of accesses to the file, the file may be moved in accordance with the trend, whereby the cost efficiency of the hierarchical storage devices can be further increased.

The number of accesses graph 500 may be created using not only the elapsed time since the file was created, but also an elapsed time since the file last updated time and date or the file last accessed time and date. In a case where an object of research is the elapsed time since the file was last accessed, it can be understood whether the file is intensively accessed at short intervals. In a case where an object of research is the elapsed time since the file was last updated, it can be understood whether the file is intensively updated at short intervals.

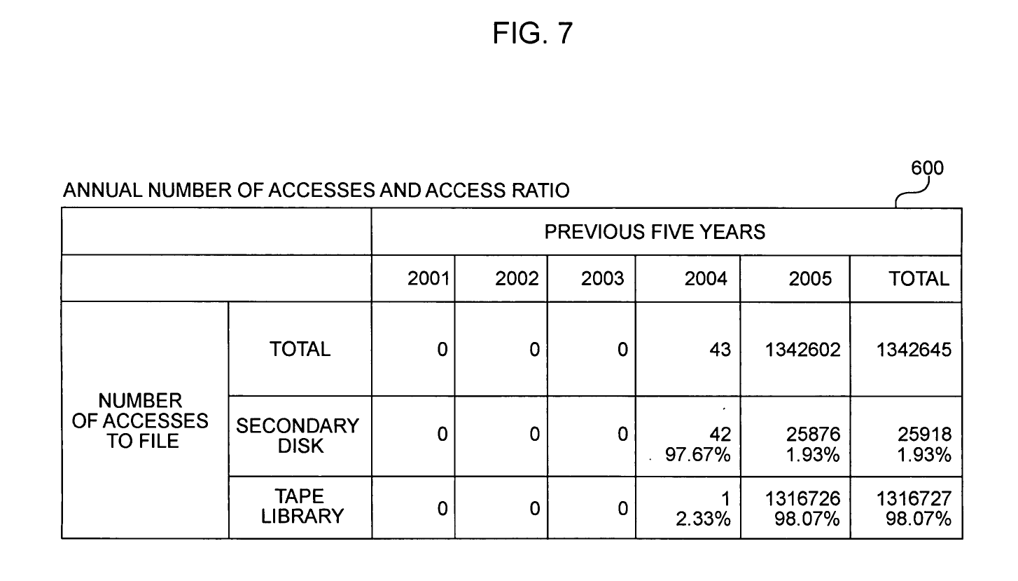

FIG. 7 is an exemplary display of an annual number of accesses table created when the research item (5) is selected. As shown in FIG. 7, an annual number of accesses table 600 shows the number of accesses to each hierarchical level for each year of the previous five years from 2001 to 2005, the total number of accesses to all of the hierarchical levels for each year, and the ratio of the number of accesses to each hierarchical level for each year to the total number of accesses to all of the hierarchical levels for an individual year. In 2004, it can be shown that the file was accessed while being stored in the secondary disk 210 at a rate of more than 90 percent. On the other hand, in 2005, the file was accessed while being stored in the tape library 220 at a high rate of more than 98 percent, whereby it can be determined that the operational efficiency decreased.

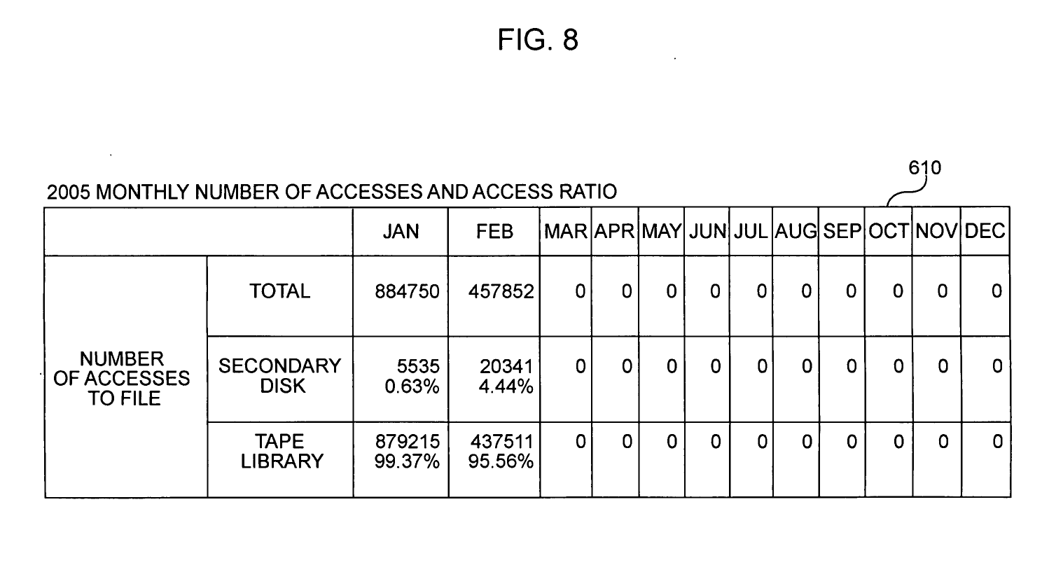

FIG. 8 is an exemplary display of a monthly number of accesses table created when the research item (5) is selected. As shown in FIG. 8, a monthly number of accesses table 610 shows the number of accesses to each hierarchical level for each month, the total number of accesses to all of the hierarchical levels for each month, and the ratio of the number of accesses to each hierarchical level for each month to the total number of accesses to all of the hierarchical levels for an individual month. It can be shown that the file was accessed while being stored in the tape library 220 at a rate of more than 99 percent in January and at a rate of more than 95 percent in February.

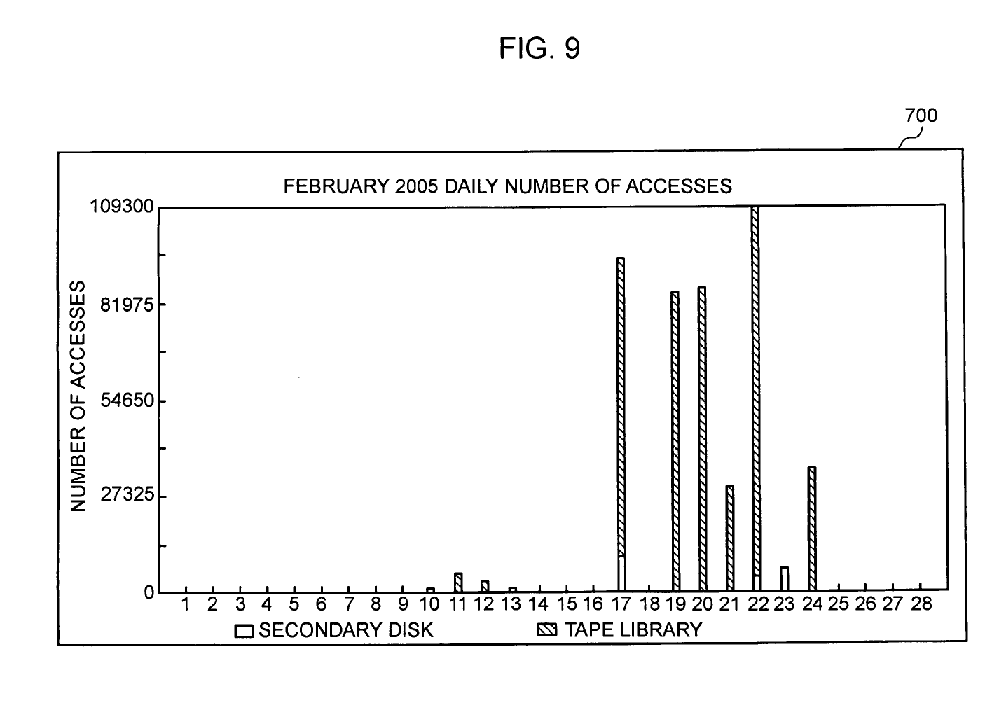

FIG. 9 is an exemplary display of a daily number of accesses graph created when the research item (5) is selected. As shown in FIG. 9, a daily number of accesses graph 700 shows the number of accesses for each day in February 2005. It can be seen from the daily number of accesses graph 700 that the file is almost always accessed while being stored in the tape library 220.

Like the graph shown in the exemplary display described above, a graph can be created by combining access history information about various hierarchical levels, year/month/day/time, etc. Consequently, information for evaluating whether the operation of the hierarchical storage management apparatus 100 is being appropriately performed can be provided to operators.

In the hierarchical storage management apparatus 100, as shown in the example in FIG. 6, the elapsed time since a file was created, last updated, or last accessed can be calculated. Consequently, information about how the number of accesses to the file changes with the elapsed time can be provided to operators. The operators can take steps to improve appropriate operations of file movement between hierarchical levels by understanding the changes in the number of accesses to the file.

Furthermore, various graphs can be rapidly created by storing information about the hierarchical levels and the access dates and times of the accessed files in a database when the files are accessed, and then collectively acquiring various combinations of the access dates and times and the hierarchical levels from the database. Consequently, for example, operators can also understand that only the secondary disk 210 temporarily lacks its capacity relative to the number of accesses thereto. In this case, for example, a magnetic disk device can be newly rented for a predetermined period without having to be purchased. Thus, a broad range of operational choices can be achieved. Accordingly, the hierarchical storage management apparatus 100 can be flexibly and appropriately operated.

In this embodiment, the setting of the hierarchical storage management apparatus 100 is performed via the network 10. However, in order to perform setting of the hierarchical storage management apparatus 100 in a local area, a keyboard, a mouse, and a display may be connected to the hierarchical storage management apparatus 100. The user interface 400 may be configured so as to be operated using the terminal device 300 via the network 10, whereby operators can more flexibly understand the usage of the storage devices.

In this embodiment, the graph created on a file-by-file basis is shown, but a graph or a table on a storage device-by-storage device basis or on a plurality of storage devices basis may be created. The overall trends of access to one or more files in one storage device can be known from the graph on a storage device-by-storage device basis. Therefore, operators can acquire useful information for evaluating whether the hierarchical storage management apparatus 100 is being desirably operated.

The processing functions described above can be implemented by a computer. In this case, a program describing the processing details of the functions of the hierarchical storage management apparatus is provided. The program is executed by a computer to achieve the processing functions on the computer. The program describing the processing details may be stored in a computer-readable recording medium such as a magnetic recording device, an optical disc, a magneto-optical recording medium, or a semiconductor memory. The magnetic recording device may be an HDD, a FD, a magnetic tape, or the like. The optical disc may be a DVD, a DVD-RAM, a CD (Compact Disc)-ROM, a CD-R (Recordable)/RW (Rewritable) disc, or the like. The magneto-optical recording medium may be an MO disk, or the like.

In a case where the program is distributed, for example, portable recording media, such as DVDs and CD-ROMs storing the program are sold. The program may be stored in a storage device of a server computer so that the program can be transmitted from the server computer to other computers via a network.

A computer executing the program, for example, stores the program, which has been stored in the portable recording medium or which has been transmitted from the server computer, into its own storage device. Subsequently, the computer reads the program from its own storage device and then executes processing in accordance with the program. The computer may directly read the program from the portable recording medium and then execute processing in accordance with the program. The computer may execute processing in accordance with a program each time the program is transmitted from the server computer.

The present invention is not limited to the foregoing embodiment. Various changes can be made to the present invention without departing from the spirit and scope of the present invention.

The principle of the present invention has been described in the context of the foregoing embodiment. It should be appreciated by those skilled in the art that various modifications and changes can be further made to the present invention. The present invention is not limited to the specific configuration and the exemplary applications shown and described in the foregoing embodiment. Accordingly, any relevant exemplary applications and equivalents are construed as being within the scope of the present invention according to the appended claims and the equivalents thereof.

What is claimed is:

1. A hierarchical storage management apparatus for managing data access to a plurality of hierarchical storage devices that have different performances, the hierarchical storage management apparatus comprising:
access history recording means for recording an access history of a data file stored in one of the plurality of hierarchical storage devices, the access history being recorded when the data file is accessed and including information about a hierarchical level in which the accessed data file is stored; and
image data generating means for generating image data that shows an access status using information about one or more specified arbitrary hierarchical levels, each piece of the information being extracted from the access history.

2. The hierarchical storage management apparatus according to claim 1, wherein the access history includes an elapsed time from at least one of file created, last updated, and last accessed times and dates to file most recently accessed time and date.

3. The hierarchical storage management apparatus according to claim 1, wherein the image data shows a calculated ratio between the information about one or more specified arbitrary hierarchical levels, each piece of the information being extracted from the access history for being compared with each other.

4. The hierarchical storage management apparatus according to claim 1, wherein the image data generating means outputs a user interface image in the form of a table that shows a combination of one or more hierarchical levels, for each of which a piece of information is extracted from the access history, and receives designation of the one or more hierarchical levels in accordance with selection and input of the one or more hierarchical levels via the user interface image.

5. The hierarchical storage management apparatus according to claim 1, wherein the image data shows the access status in the form of a graph or a table.

6. The hierarchical storage management apparatus according to claim 1, wherein the image data shows the access status on an annual, a monthly, or a daily basis.

7. A hierarchical storage management method of managing data access to a plurality of hierarchical storage devices that have different performances, the hierarchical storage management method comprising the steps of:
causing access history recording means to record an access history of a data file stored in one of the plurality of hierarchical storage devices, the access history being recorded when the data file is accessed and including information about a hierarchical level in which the accessed data file is stored; and
causing image data generating means to generate image data that shows an access status using information about one or more specified arbitrary hierarchical levels, each piece of the information being extracted from the access history.

8. A hierarchical storage management program for managing data access to a plurality of hierarchical storage devices that have different performances, the hierarchical storage management program comprising:
access history recording means for recording an access history of a data file stored in one of the plurality of the hierarchical storage devices, the access history being recorded when the data file is accessed and including information about a hierarchical level in which the accessed data file is stored; and
image data generating means for generating image data that shows an access status using information about one or more specified arbitrary hierarchical levels, each piece of the information being extracted from the access history.

9. A hierarchical storage management apparatus for managing data access to a plurality of hierarchical storage devices that have different performances, the hierarchical storage management apparatus comprising:
an access history recorder that records an access history of a data file stored in one of the plurality of hierarchical storage devices, the access history being recorded when the data file is accessed and including information about a hierarchical level in which the accessed data file is stored; and
an image data generator that generates image data that shows an access status using information about one or more specified arbitrary hierarchical levels, each piece of the information being extracted from the access history.

10. A hierarchical storage management method of managing data access to a plurality of hierarchical storage devices that have different performances, the hierarchical storage management method comprising the steps of:
causing an access history recorder to record an access history of a data file stored in one of the plurality of hierarchical storage devices, the access history being recorded when the data file is accessed and including information about a hierarchical level in which the accessed data file is stored; and
causing an image data generator to generate image data that shows an access status using information about one or more specified arbitrary hierarchical levels, each piece of the information being extracted from the access history.

11. A hierarchical storage management program for managing data access to a plurality of hierarchical storage devices that have different performances, the hierarchical storage management program comprising:
an access history recorder that records an access history of a data file stored in one of the plurality of the hierarchical storage devices, the access history being recorded when the data file is accessed and including information about a hierarchical level in which the accessed data file is stored; and
an image data generator that generates image data that shows an access status using information about one or more specified arbitrary hierarchical levels, each piece of the information being extracted from the access history.
